(19) United States
(12) Patent Application Publication
(10) Pub. No.: US 2023/0127368 A1
(43) Pub. Date: Apr. 27, 2023

(54) Coin-Type Secondary Battery with Conductive Layer on Inner Surface of Battery Case

(71) Applicant: LG Energy Solution, Ltd., Seoul (KR)

(72) Inventors: Hyunwoong Yun, Daejeon (KR); Sungjoong Kang, Daejeon (KR)

(73) Assignee: LG Energy Solution, Ltd., Seoul (KR)

(21) Appl. No.: 17/908,151

(22) PCT Filed: Oct. 8, 2021
(86) PCT No.: PCT/KR2021/013895

§ 371 Date: Aug. 30, 2022

(30) Foreign Application Priority Data
Oct. 27, 2020 (KR) 10-2020-0140348
Oct. 27, 2020 (KR) 10-2020-0140607

(51) Int. Cl. H01M 50/124; H01M 50/109; H01M 50/119; H01M 10/04; H01M 50/417

(52) U.S. Cl. CPC H01M 50/1243; H01M 50/109; H01M 50/119; H01M 10/0422; H01M 50/417; H01M 2004/027

(57) ABSTRACT

The present disclosure provides a secondary battery configured such that an electrode assembly including a positive electrode, a separator, and a negative electrode is housed in a battery case together with an electrolyte solution, wherein the battery case is made of metal, and a conductive layer made of one selected from the group consisting of a conductive carbon layer, a conductive polymer layer, and a conductive epoxy layer is formed on a part or the whole of the inner surface of the battery case coming into contact with the electrolyte solution.

### CROSS-REFERENCE TO RELATED APPLICATIONS

This application is a national phase entry under 35 U.S.C. § 371 of International Application No. PCT/KR2021/013895, filed on Oct. 8, 2021, which claims priority to Korean Patent Application No. 10-2020-0140607 filed on Oct. 27, 2020 and Korean Patent Application No. 10-2020-0140348 filed on Oct. 27, 2020, the disclosures of which are incorporated herein by reference in their entireties.

### TECHNICAL FIELD

The present disclosure relates to a secondary battery having a conductive layer formed on the inner surface of a battery case.

### BACKGROUND

Due to the rapid increase in the use of fossil fuels, the demand for the use of alternative energy or clean energy is increasing, and as part thereof, the fields that are being studied most actively are the fields of power generation and power storage using electrochemistry.

At present, a secondary battery is a representative example of an electrochemical device that utilizes such electrochemical energy, and the range of use thereof tends to be gradually expanding.

Recently, along with the increase of the technological development and demand for mobile devices such as portable computers, portable phones, and cameras, the demand for secondary batteries has also sharply increased as an energy source. Among such secondary batteries is a lithium secondary battery exhibiting high charge/discharge characteristics and lifetime characteristics and being environmentally friendly, in which much research has been carried out and which is now commercialized and widely used.

Generally, the secondary battery has a structure in which an electrode assembly comprising a positive electrode, a negative electrode, and a porous separator is built into in a battery case in a state of being impregnated with a non-aqueous electrolyte.

In this case, depending upon the shape of a battery case, a secondary battery may be generally classified as a cylindrical secondary battery or a prismatic secondary battery in which a stacked/folded type, or wound type electrode assembly is housed in a case made of metal as a battery case, a pouch type secondary battery in which a stacked type or stacked/folding type electrode assembly is built into a pouch type battery case made of an aluminum laminate sheet, and a coin-type secondary battery in which a coin-type electrode assembly is housed in an upper case and a lower case made of metal.

Here, the exterior material of the cylindrical, prismatic, or coin-type secondary battery, i.e., the battery case, is generally made of metal, especially stainless steel (SUS).

However, there is a problem that when such a metal comes into contact with an electrolyte, corrosion occurs, and especially when an imide-based lithium salt is used, corrosion is deepened.

In this regard, conventionally, corrosion has been suppressed by a method of coating the battery case of such a secondary battery with an inexpensive metal such as Cr, Zn, Sn, etc., which does not easily cause corrosion, but these also have a problem that not only a sufficient corrosion-preventing effect cannot be obtained with a metal, but also a browning phenomenon occurs on the metal surface.

Therefore, there is a need to develop a technology for a secondary battery that can solve the above problems and effectively prevent the corrosion of a metal can regardless of the type of electrolyte.

### DETAILED DESCRIPTION OF THE INVENTION

### Technical Problem

The present disclosure has been made to solve the above-mentioned problems and other technical problems that have yet to be resolved.

Specifically, an object of the present disclosure is to provide a secondary battery that can effectively suppress the corrosion of the secondary battery case due to contact with the electrolyte.

### Technical Solution

In order to achieve the above object, according to one embodiment of the present disclosure, there is provided a secondary battery configured such that an electrode assembly including a positive electrode, a separator, and a negative electrode is housed in a battery case together with an electrolyte solution,

wherein the battery case is made of metal, and a conductive layer made of one selected from the group consisting of a conductive carbon layer, a conductive polymer layer, and a conductive epoxy layer is formed on a part or the whole of the inner surface of the battery case coming into contact with the electrolyte solution.

Specifically, depending upon the shape of the secondary battery,

as an example, the electrode assembly is a coin-type electrode assembly,

the battery case comprises a first case for housing the electrode assembly; and a second case for covering the upper end part of the first case,

a conductive layer made of one selected from the group consisting of the conductive carbon layer, the conductive polymer layer, and the conductive epoxy layer is formed on an inner surface where the first case and the second case come into contact with an electrolyte solution, and

the conductive carbon layer may comprise graphene.

Moreover, the secondary battery further comprises a spring and a spacer that fill an inner space excluding the electrode assembly in the inside of the first case and the second case,

the spring and the spacer are made of metal,

a conductive layer made of one selected from the group consisting of a conductive carbon layer, a conductive polymer layer, and a conductive epoxy layer is formed on a surface where the spring and the spacer come into contact with the electrolyte solution, and

the conductive carbon layer may comprise graphene.

Further, the secondary battery may further comprise a gasket for sealing the first case and the second case.

In another example, the secondary battery is a cylindrical secondary battery,

the electrode assembly is a jelly-roll type or stack/folding type electrode assembly,

the battery case comprises a cylindrical can that includes a housing part in which the electrode assembly and the electrolyte are housed together and a beading part located at an upper part of the housing part; and a cap assembly that is mounted on the opened upper end part of the cylindrical can and comprises an upper end cap as a protrusion-type electrode terminal, and

the conductive layer may be formed on a bottom surface of the cylindrical can and the partial or whole surface of the cap assembly toward the inner surface of the secondary battery.

More specifically, a gasket is mounted on the upper part of the beading part of the cylindrical can,

the cap assembly is configured such that a safety device for current interruption (PTC device) and a safety vent for internal pressure drop are stacked under the upper end cap, and a current interruption device (CID) is formed at the lower end of the safety vent,

the electrode assembly comprises a positive electrode tab and a negative electrode tab that are drawn out from the electrode assembly, wherein the positive electrode tab is connected to the cap assembly, and the negative electrode tab is connected to the bottom surface spaced apart from the housing part of the cylindrical can, and

the conductive layer is formed on the inside surface of the secondary battery, in at least one member selected from the group consisting of the top cap, the bottom surface of the cylindrical can, the safety device for blocking current, a safety vent, a current interruption device, a positive electrode tab, and a negative electrode tab.

In yet another example, the electrode assembly is a jelly-roll type or stack/folding type electrode assembly,

the battery case comprises a rectangular can body that is opened in its upper end and houses the electrode assembly and the electrolyte solution together; and a top cap including cap terminals that are coupled and sealed to the upper end part of the can body and are connected to the electrode terminals of the electrode assembly, and

a conductive layer is formed on a surface of the cap terminals of the top cap toward the inner surface of the secondary battery.

In this case, the electrode assembly comprises a positive electrode tab and a negative electrode tab drawn out from the electrode assembly, wherein the positive tab and the negative tab are respectively connected to the cap terminals, and

a conductive layer may be formed on the inside surface of the secondary battery, in at least one member selected from the group consisting of the positive electrode tab and the negative electrode tab.

On the other hand, in any of the above examples, the metal may be made of any one selected from the group consisting of aluminum, nickel, stainless steel (SUS), copper, iron, bronze, and brass.

The secondary battery may further comprise a hollow center pin inserted into the center of the electrode assembly.

The conductive layer may be formed to a thickness of 0.01 μm to 100 μm.

On the other hand, in a specific example, the conductive carbon layer may comprise graphene and a binder polymer.

The conductive polymer layer may comprise at least one conductive polymer selected from the group consisting of poly(3,4-ethylenedioxythiophene)/poly(4-styrene sulfonate (PEDOT/PSS), polyaniline (PANI), polypyrrole (PPy), polythiophene (PT), polyacetylene (PA), and poly para-phenylene vinylene (PPV).

The conductive epoxy layer may comprise at least one conductive filler selected from the group consisting of gold, platinum, silver, copper, or nickel metal powder, carbon or carbon fiber, graphite, and composite powder, and an epoxy polymer.

### BRIEF DESCRIPTION OF THE DRAWINGS

FIG. 1 is an exploded perspective view of a coin-type secondary battery according to an embodiment of the present disclosure;

FIG. 2 is a cross-sectional schematic view of a coin-type secondary battery according to an embodiment of the present disclosure;

FIG. 3 is a schematic diagram of a cylindrical secondary battery according to another embodiment of the present disclosure; and FIG. 4 is a schematic diagram of a prismatic secondary battery according to another embodiment of the present disclosure.

### DETAILED DESCRIPTION OF THE EMBODIMENTS

Hereinafter, the present disclosure will be described in more detail for a better understanding of the present disclosure.

Terms or words used in the present specification and claims should not be construed as limited to ordinary or dictionary terms, and the present disclosure should be construed with meanings and concepts that are consistent with the technical idea of the present disclosure based on the principle that the inventors may appropriately define concepts of the terms to appropriately describe their own disclosure in the best way.

The technical terms provided herein is merely used for the purpose of describing particular embodiments only, and is not intended to be limiting of the present disclosure. The singular forms “a,” “an,” and “the” are intended to include the plural forms as well, unless the context clearly indicates otherwise.

Further, throughout the specification, when a portion is referred to as “including” a certain component, it means that the portion can further include other components, without excluding the other components, unless otherwise stated.

According to one embodiment of the present disclosure, there can be provided a secondary battery configured such that an electrode assembly including a positive electrode, a separator, and a negative electrode is housed in a battery case together with an electrolyte solution, wherein the battery case is made of metal, and a conductive layer made of one selected from the group consisting of a conductive carbon layer, a conductive polymer layer, and a conductive epoxy layer is formed on a part or the whole of the inner surface of the battery case coming into contact with the electrolyte solution.

Specifically, the position where the conductive layer is formed may differ depending on the type of secondary battery.

Specifically, the conductive layer may be formed on a surface coming into contact with an electrolyte solution, and more specifically, the conductive layer may be formed at a position at which it should have conductivity while coming into contact with the electrolyte solution.

In one example, first, the secondary battery may be a coin-type secondary battery,

the electrode assembly is a coin-type electrode assembly,

the battery case comprises a first case for housing the electrode assembly; and a second case for covering the upper end part of the first case,

a conductive layer made of one selected from the group consisting of the conductive carbon layer, the conductive polymer layer, and the conductive epoxy layer is formed on an inner surface where the first case and the second case come into contact with an electrolyte solution, and

the conductive carbon layer may comprise graphene.

More specifically, the secondary battery further comprises a spring and a spacer that fill an inner space excluding the electrode assembly in the inside of the first case and the second case,

the spring and the spacer are made of metal,

a conductive layer made of one selected from the group consisting of a conductive carbon layer, a conductive polymer layer, and a conductive epoxy layer is formed on a surface where the spring and the spacer come into contact with the electrolyte solution, and

the conductive carbon layer may comprise graphene.

That is, the first case, the second case, the spring, and the spacer are made of metal, and the degree of corrosion is severe depending on what kind of material is used as the electrolyte solution, the lifespan characteristics are deteriorated, or it will be unusable any more or the safety may be threatened.

Thus, according to the present disclosure, a conductive layer can be formed on a surface where the first case, the second case, the spring, and the spacer come into contact with the electrolyte, thereby preventing corrosion due to the electrolyte solution while having conductivity.

Meanwhile, the secondary battery may further include a gasket for sealing the first case and the second case.

The gasket is generally made of an insulating material and thus, the conductive layer need not be formed. However, the conductive layer may also be formed on a surface of the gasket, and such a structure is not excluded.

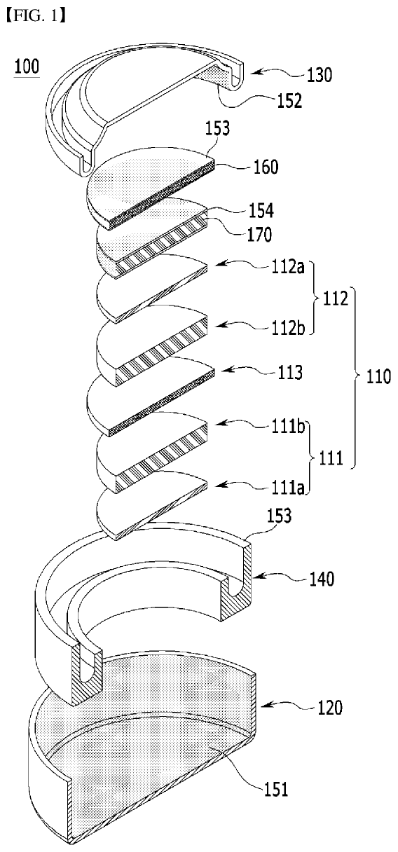

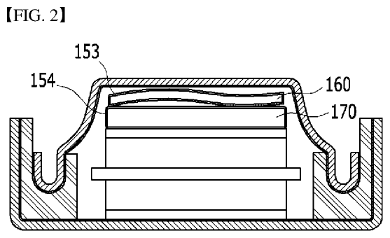

In the present disclosure, a perspective view of a coin-type secondary battery having such a conductive layer formed therein is shown in FIG. 1, and a schematic diagram of the cross section is shown in FIG. 2.

Referring to FIGS. 1 and 2 together, the coin-type secondary battery 100 of the present disclosure includes an electrode assembly 110; a first case 120 for housing the electrode assembly 110; a second case 130 assembled so as to cover the upper end of the first case 120; and a spring 160 and a spacer 170 that fill an inner space excluding the electrode assembly in the inside of the first case and the second case.

At this time, the electrode assembly 110 includes a positive electrode 111, a negative electrode 112, and a separator 113 interposed between the positive electrode 111 and the negative electrode 112, wherein the positive electrode 111, the negative electrode 112 and the separator 113 have a coin-type structure.

Meanwhile, the first case 120, the second case 130, the spring 160 and the spacer 170 are made of metal and thus, in order to prevent corrosion due to the reaction with an electrolyte solution, conductive layers 151, 152, 153 and 154 made of one selected from the group consisting of a conductive carbon layer, a conductive polymer layer, and a conductive epoxy layer are formed on a surface coming into contact with the electrolyte solution, respectively.

Meanwhile, the coin-type secondary battery 100 may further include a gasket 140 for sealing the first case 120 and the second case 130.

Moreover, the conductive layers 151, 152, 153 and 154 preferably include a material having conductivity, considering that the cases, spring and spacer of the coin-type secondary battery are made of metal, and these themselves serve as electrode terminals. In particular, when the conductive layers 151, 152, 153 and 154 are formed wholly on the inner surface of the case, ensuring conductivity as much as corrosion is prevented is a very important issue. Even if the corrosion is prevented, the performance as a secondary battery will be eventually deteriorated if the conductivity is not sufficiently secured, and thus there is no choice but to lose the meaning of the invention.

Therefore, the conductive layers 151, 152, 153 and 154 may be made of one selected from the group consisting of a conductive carbon layer, a conductive polymer layer, and a conductive epoxy layer.

Such specific materials will be described again below.

On the other hand, in another embodiment of the present disclosure, the secondary battery is a cylindrical secondary battery,

the electrode assembly is a jelly-roll type or stack/folding type electrode assembly,

the battery case comprises a cylindrical can that includes a housing part in which the electrode assembly and the electrolyte solution are housed together and a beading part located at an upper part of the housing part; and a cap assembly that is mounted on the opened upper end part of the cylindrical can and comprises an upper end cap as a protrusion-type electrode terminal, and

the conductive layer may be formed on a bottom surface of the cylindrical can and the partial or whole surface of the cap assembly toward the inner surface of the secondary battery.

More specifically, a gasket is mounted on the upper part of the beading part of the cylindrical can,

the cap assembly is configured such that a safety device for current interruption (PTC device) and a safety vent for internal pressure drop are stacked under the upper end cap, and a current interruption device (CID) is formed at the lower end of the safety vent,

the electrode assembly comprises a positive electrode tab and a negative electrode tab that are drawn out from the electrode assembly, wherein the positive electrode tab is connected to the cap assembly, and the negative electrode tab is connected to the bottom surface spaced apart from the housing part of the cylindrical can, and

the conductive layer is formed on the inside surface of the secondary battery, in at least one member selected from the group consisting of the top cap, the bottom surface of the cylindrical can, the safety device for blocking current, a safety vent, a current interruption device, a positive electrode tab, and a negative electrode tab.

That is, the bottom part of the cylindrical can and the components of the cap assembly are made of metal, and the degree of corrosion is severe depending on what kind of material is used as the electrolyte solution, the lifespan characteristics are deteriorated, or it will be unusable any more or the safety may be threatened.

Additionally, the components necessarily require conductivity.

Thus, according to the present disclosure, a conductive layer can be formed on a surface where the components come into contact with the electrolyte solution, thereby preventing corrosion due to the electrolyte solution while having conductivity.

On the other hand, the housing part, the beading part, and the gasket excluding the bottom surface of the cylindrical can do not necessarily require conductivity as described above, and thus the conductive layer does not need to be formed. However, a conductive layer may also be formed on the surfaces of these components, and such a structure is not excluded.

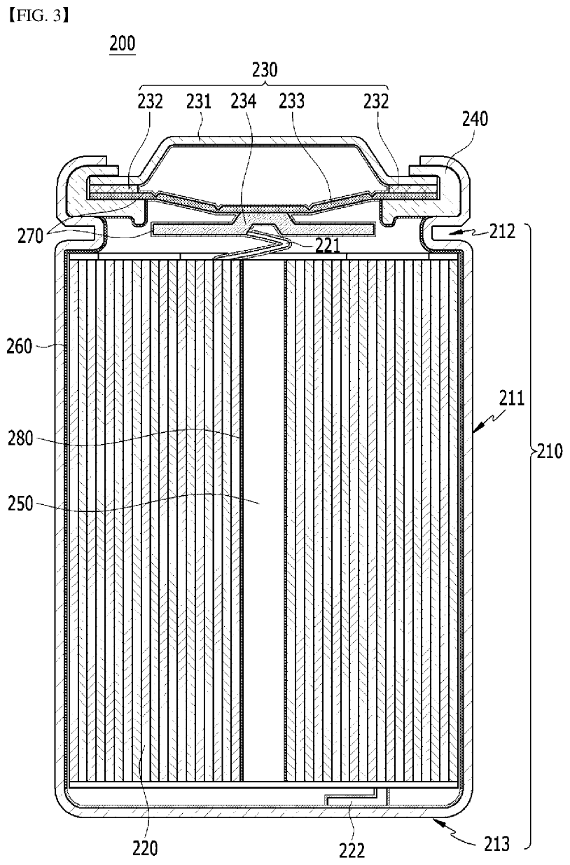

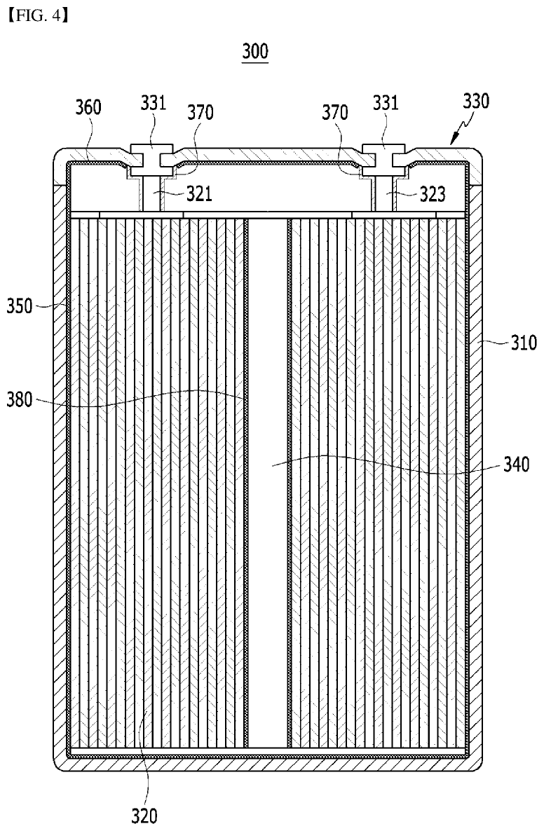

In the present disclosure, a perspective view of a cylindrical secondary battery in which such a conductive layer is formed is shown in FIG. 3 below.

Referring to FIG. 3, the secondary battery 200 according to the present disclosure is structured such that an electrode assembly 220 including a positive electrode, a separator, and a negative electrode is housed together with an electrolyte solution in a cylindrical can 210 including a housing part 211 and a beading part 212 as a battery case, wherein a cap assembly 230 including the upper end cap 231 is located at the opened upper end part of the cylindrical can 210 and seals the cylindrical can 210.

In this case, the electrode assembly 220 may be a jelly-roll type or a stack/folding type electrode assembly, without being limited thereto.

The jelly-roll type electrode assembly is manufactured by interposing a sheet-type separator between a sheet-type positive electrode and a sheet-type negative electrode and winding it.

The stack/folding type electrode assembly is manufactured by arranging a unit electrode, a full cell stacked so that electrodes having the same polarity are located at both ends, and a bi-cell stacked so that electrodes having different polarities are located at both ends, on a sheet-type separation film, and winding the same.

Specific configurations of the jelly-roll type electrode assembly and the stack/folding type electrode assembly are conventionally known, and thus detailed descriptions thereof will be omitted herein.

More specifically, the secondary battery 200 according to the present disclosure includes a gasket 240 mounted on the upper end part of the beading part 212 of the cylindrical can 210, and is formed in a structure in which the cap assembly 230 includes an upper end cap 231, a current interruption safety device (PTC device, 232) stacked under the upper end cap 231 and a safety vent 233 for internal pressure drop, and a current interruption device (CID) 234 formed at the lower end of the safety vent 233.

Further, the positive electrode tab 221 and the negative electrode tab 222 are drawn out from the electrode assembly 220, the positive electrode tab 221 is connected to the cap assembly 230, and the negative electrode tab 222 is connected to a bottom surface 213 spaced apart from a housing part 211 of the cylindrical can 210.

Here, the current interruption safety device 232, the safety vent 233, and the current interruption device 234 all are preferably structures through which current flows, which are formed in order to ensure the safety of the secondary battery.

Since other specific contents are conventionally known, a description thereof will be omitted herein.

On the other hand, as described above, the current interruption safety device 232, the safety vent 233, the current interruption device 234, as well as the upper end cap 231 serving as a positive electrode terminal, the bottom surface 213 of the cylindrical can 210 serving as a negative electrode terminal, and the positive electrode tab 221 and the negative electrode tab 222 preferably have conductivity. Therefore, a conductive layer 260 may be formed on the inside surface of the cylindrical can 210 in order to prevent corrosion due to leakage of the electrolyte solution while maintaining conductivity, in which the secondary battery 200 includes the upper end cap 231, the bottom surface 213 of the cylindrical can, the current interruption safety device 232, the safety vent 233, the current interruption device 234, the positive electrode tab 221, and the negative electrode tab 222.

In this case, the conductive layer 260 may be formed wholly on the surface of the above members exposed inside the secondary battery, but may be formed only on a surface toward the electrode assembly in each member.

On the other hand, a conductive layer for corrosion prevention may be formed on the housing part 211, the beading part 212, and the gasket 140 excluding the bottom surface 213 of the cylindrical can 210, without being limited thereto, or the above components do not necessarily require conductivity, and thus other anti-corrosion layers 260 may be formed.

Furthermore, the secondary battery 200 according to the present disclosure may further include a hollow center pin 250 inserted into the center of the jelly-roll type electrode assembly 220.

At this time, the center pin 250 may also be made of any one selected from the group consisting of metal, specifically aluminum, nickel, stainless steel (SUS), copper, iron, bronze, and brass, which thus causes corrosion to the electrolyte. However, the conductivity is not necessarily required.

Therefore, although the outer surface and the inner surface of the center pin 250 are not clearly shown in the figure, also in the outer surface coming into contact with an electrolyte solution in the center pin 250, a conductive layer may be formed, other anti-corrosion layers 280 may be additionally formed, and more specifically, the anti-corrosion layer 280 may be formed up to the hollow inner surface.

That is, according to the present disclosure, the conductive layer 270 may be formed at a portion that is likely to come into contact with the electrolyte solution, whereby the conductivity may not be lowered while effectively preventing corrosion due to contact with the electrolyte solution, which is thus more preferable.

In another embodiment, the secondary battery is a prismatic secondary battery,

the electrode assembly is a jelly-roll type or stack/folding type electrode assembly,

the battery case comprises a rectangular can body that is opened in its upper end and houses the electrode assembly and the electrolyte solution together; and a top cap including cap terminals that are coupled and sealed to the upper end part of the can body and are connected to the electrode terminals of the electrode assembly, and

a conductive layer is formed on a surface of the cap terminals of the top cap toward the inner surface of the secondary battery.

More specifically, the electrode assembly comprises a positive electrode tab and a negative electrode tab drawn out from the electrode assembly, wherein the positive tab and the negative tab are respectively connected to the cap terminals, and

a conductive layer is formed on the inside surface of the secondary battery, in at least one member selected from the group consisting of the positive electrode tab and the negative electrode tab.

That is, the inner surface of the cap terminals of the top cap, the positive electrode tab, and the negative electrode tab are made of metal, and the degree of corrosion is severe depending on what kind of material is used as the electrolyte solution, the lifespan characteristics are deteriorated, or it will be unusable any more or the safety may be threatened.

Moreover, these components necessarily require conductivity.

Therefore, according to the present disclosure, a conductive layer can be formed on a surface where the components come into contact with the electrolyte solution, thereby preventing corrosion due to the electrolyte solution while having conductivity.

On the other hand, the can body, the portion excluding the cap terminals of the top cap, and the gasket do not necessarily require conductivity, and thus the conductive layer does not need to be formed. However, a conductive layer may be formed even on the surface of these components, and such a structure is not excluded.

In the present disclosure, a perspective view of a prismatic secondary battery in which such a conductive layer is formed is shown in FIG. 4 below.

Referring to FIG. 4, the secondary battery 300 according to the present disclosure comprises a rectangular can body 310 that is opened in its upper end and houses the electrode assembly 320 and the electrolyte solution together, and a top cap 330 including cap terminals 331 that are coupled and sealed to the upper end part of the can body 310 and are connected to the electrode terminals 321 and 323 of the electrode assembly 320.

Here, the electrode assembly 320 is the same as those described for the cylindrical secondary battery.

Further, the electrode assembly 320 includes a positive electrode tab 321 and a negative electrode tab 323 drawn upward from the electrode assembly 320, and the positive electrode tab 321 and the negative electrode tab 323 are respectively connected to the can terminals 331.

At this time, since the positive electrode tab 321, the negative electrode tab 323, and the cap terminals 331 must have conductivity, a conductive layer 270 made of one selected from the group consisting of a conductive carbon layer, a conductive polymer layer, and a conductive epoxy layer are formed on the inside surface of the secondary battery 300.

On the other hand, a conductive layer for corrosion prevention may be formed on the portion excluding the cap terminals 331 of the prismatic can body 310 and the top cap 330, without being limited thereto, or the components do not necessarily require conductivity and thus, other anti-corrosion layers 350 may be formed.

Furthermore, the secondary battery 300 according to the present disclosure may further include a hollow center pin 340 inserted into the center of the jelly-roll type electrode assembly 320.

At this time, the center pin 340 may also made of metal, specifically any one selected from the group consisting of aluminum, nickel, stainless steel (SUS), copper, iron, bronze, and brass, which thus causes corrosion to the electrolyte solution. However, the conductivity is not necessarily required.

Therefore, although the outer surface and inner surface of the center pin 340 are not clearly shown in the figure, a conductive layer may also be formed on the outer surface coming into contact with an electrolyte solution in the center pin 340, other anti-corrosion layers 380 may be additionally formed, and more specifically, the anti-corrosion layer 380 may be formed up to the hollow inner surface.

On the other hand, in all cases, the conductive layer may have a thickness of 0.01 μm to 100 μm, specifically 0.5 μm to 30 μm, and more specifically, 1 μm to 10 μm.

If the conductive layer is too thin outside the above range, it cannot exhibit a sufficient anti-corrosion effect, and if the conductive layer is too thick, the conductivity may be lowered or the bulk energy density may be lowered, which is thus not preferable.

The metals constituting the above components may be made of any one selected from the group consisting of aluminum, nickel, stainless steel (SUS), copper, iron, bronze, and brass, and specifically, it may be made of aluminum or stainless steel (SUS), and more specifically, it may be made of stainless steel (SUS).

On the other hand, since the conductive layer should have conductivity as described above, it may be made of, specifically, one selected from the group consisting of a conductive carbon layer, a conductive polymer layer, and a conductive epoxy layer.

Here, the conductive carbon layer may include graphene as a carbon-based material rather than a general carbon material, and further include a binder polymer.

When using the graphene, it can exhibit superior conductivity compared to the case of using other carbon-based materials. According to the present disclosure, for a coin-type secondary battery, ensuring conductivity is an important factor, and thus it is essential to ensure sufficient conductivity. Otherwise, the secondary battery performance may be deteriorated, and thus it is important to use graphene exhibiting most excellent conductivity among carbon-based materials.

The binder polymer is used for bonding between a metal member and a conductive carbon layer, and is not limited as long as it has a general binding component, and examples thereof may be at least one selected from the group consisting of polyvinylidene fluoride, polyvinyl alcohol, carboxymethylcellulose (CMC), starch, hydroxypropylcellulose, regenerated cellulose, polyvinylpyrrolidone, tetrafluoroethylene, polyethylene, polypropylene, ethylene-propylene-diene terpolymer (EPDM), sulfonated EPDM, styrene butylene rubber, and fluorine rubber.

In this case, the graphene and the binder polymer may be contained in a weight ratio of 1:99 to 99:1, and specifically in a weight ratio of 3:7 to 7:3.

When the content of the graphene is low outside the above range, sufficient conductivity cannot be obtained. On the contrary, when the content of the binder polymer is too low, sufficient binding strength of the conductive carbon layer cannot be obtained, which is thus not preferable.

For such a conductive carbon layer, a coating film forming method commonly used in the art may be used. For example, the conductive carbon layer can be formed by using a wet coating method such as gravure coating, slot die coating, spin coating, spray coating, bar coating and dip coating, or a dry coating method such as thermal evaporation, E-beam evaporation, chemical vapor deposition, and sputtering.

For the conductive polymer layer, polymers commonly known as conductive polymers may be used. For example, the conductive polymer layer may include at least one conductive polymer selected from the group consisting of poly(3,4-ethylenedioxythiophene)/poly(4-styrene sulfonate) (PEDOT/PSS), polyaniline (PANI), polypyrrole (PPy), polythiophene (PT), polyacetylene (PA), and poly para-phenylene vinylene (PPV).

The conductive polymer layer may be formed by preparing a conductive polymer melt or a mixed solution in which these are dissolved in a solvent, and subjecting it to various wet coating methods as described in the coating method of the conductive carbon layer. At this time, when the conductive polymer is mixed with a solvent, the solvent may be a polar organic solvent, and for example, chloroform, dichloromethane, m-cresol, tetrahydrofuran (THF), and dimethylformamide (DMF) and the like may be mentioned.

On the other hand, the conductive polymer does not require a separate binder material and the like because the polymer itself exhibits a binding force.

However, for a more rigid binding, it may additionally include a binder polymer as disclosed in the conductive carbon layer, wherein the content thereof may be 0.1 to 10% by weight based on the total weight of the conductive polymer layer.

The conductive epoxy layer may include a conductive filler and an epoxy polymer.

Here, the conductive filler may be at least one selected from the group consisting of metal powders of gold, platinum, silver, copper, or nickel, carbon or carbon fibers, graphite, and composite powder.

The epoxy polymer is a component that binds the conductive filler, and examples thereof may be at least one selected from the group consisting of acrylic-based, epoxy-based, polyurethane-based, silicon-based, polyimide-based, phenolic-based, polyester-based polymer materials, composite polymer resins and low melting point glass, without being limited thereto.

Meanwhile, the conductive epoxy layer may be classified into a room-temperature drying type, a room-temperature curing type, a heat-curing type, a high-temperature sintering type, and a UV curing type, based on the production method.

The room-temperature drying type may be formed by incorporating a conductive filler into an acrylic polymer such as acrylic-based and a solvent, and drying it at room temperature, and the room-temperature curing type is a two-component type and may be formed by additionally containing a highly reactive curing agent and curing a solvent containing a conductive filler and an epoxy polymer.

Further, the heat-curing type can be formed by applying heat to a solvent containing a conductive filler, mainly using an epoxy-based epoxy polymer, and the high-temperature sintering type can be formed by curing by heat treatment at a high temperature, and the UV-curable type can be formed by curing by the irradiation with UV.

In this case, the conductive filler and the epoxy binder may also be contained in a weight ratio of 1:99 to 99:1, specifically, in a weight ratio of 7:3 to 3:7.

When the content of the conductive filler is too low outside the above range, the conductivity decreases and thus the resistance increases, and when the content of the epoxy polymer is too low, the binding force of the conductive filler cannot be obtained, which is thus not preferable.

On the other hand, it is more preferable that the conductive layer has a configuration that can effectively prevent corrosion by an electrolyte solution even after long-term use while having excellent conductivity, and specifically, it may be a conductive polymer layer or a conductive epoxy layer.

However, the electrolyte contains a non-aqueous electrolyte and a lithium salt, and the coin-type secondary battery according to the present disclosure is more effective when a lithium imide-based salt is used as the lithium salt.

The lithium imide-based salt may be lithium bis(fluorosulfonyl)imide, lithium bis(trifluoromethanesulfonyl)imide or lithium bis(perfluoroethylsulfonyl)imide. Preferably, the lithium imide-based salt is lithium bis(fluorosulfonyl)imide or lithium bis(trifluoromethanesulfonyl)imide.

Hereinafter, preferred examples of the present disclosure, comparative examples compared thereto, and experimental examples for evaluating them will be described. However, it will be apparent to those skilled in the art that the above examples are for illustrative purposes only and various changes and modifications can be made within the scope and spirit of the present disclosure. It goes without saying that such changes and modifications fall within the scope and spirit of the appended claims.

### <Preparation Example 1> (Conductive Carbon Layer Precursor Solution)

10 g of graphene as a conductive material was put in 200 g of NMP solvent, and then dispersed by adding an H-NBR dispersant, which was mixed with 5 g of PVdF as a binder to prepare a conductive carbon layer precursor solution.

### <Preparation Example 2> (Conductive Carbon Layer Precursor Solution)

10 g of natural graphite as a conductive material was put in 200 g of NMP solvent, and then dispersed by adding an H-NBR dispersant, which was mixed with 5 g of PVdF as a binder to prepare a conductive carbon layer precursor solution.

### <Preparation Example 3> (Conductive Carbon Layer Precursor Solution)

10 g of acetylene black as a conductive material was put in 200 g of NMP solvent dispersed by adding an H-NBR dispersant, which was mixed with 5 g of PVdF as a binder to prepare a conductive carbon layer precursor solution.

### <Preparation Example 4> (Conductive Polymer Layer Precursor Solution)

10 g of polypyrrole as a conductive polymer was mixed with 100 g of dimethylformamide (DMF) as a solvent, and the mixture was stirred (40° C.) for 48 hours with a magnetic bar to prepare a conductive polymer layer precursor solution.

### <Preparation Example 5> (Conductive Epoxy Layer Precursor Solution)

8331S product (two-component electroconductive epoxy adhesive containing silver) available from MG Chemicals was used.

### <Preparation Example 6> (Binder Solution)

7 g of polymethyl methacrylate (PMMA) as a polymer was mixed with 100 g of dimethylformamide (DMF) as a solvent, and the mixture was stirred (90° C.) for 48 hours with a magnetic bar to prepare a binder solution.

### Example 1

The conductive carbon layer precursor solution prepared in Preparation Example 1 was coated (spray coated) onto the surface where the first case, the second case, the spring, and the spacer as a coin-type battery case could come into contact with the electrolyte solution as shown in FIG. 1. A positive electrode mixture having a composition of 95 wt. % of positive active material (LiNi_{0.6}Co_{0.2}MnO₂O₂), 2.5 wt. % of Super-P (conductive material), and 2.5 wt. % of PVDF (binder) was added to NMP (N-methyl-2-pyrrolidone) as a solvent to prepare a positive electrode slurry, and then the slurry was coated (100 μm) onto an aluminum current collector substrate to prepare a coin-type positive electrode.

A negative electrode mixture having a composition of 95 wt. % of artificial graphite, 2.5 wt. % of Super-P (conductive material), and 2.5 wt. % of PVDF (binder) was added to NMP (N-methyl-2-pyrrolidone) as a solvent to prepare a negative electrode slurry, and then the slurry was coated (100 μm) onto a copper current collector substrate to prepare a coin-type negative electrode.

A polyethylene-based separator was interposed between the prepared positive electrode and negative electrode to prepare an electrode assembly, and the electrode assembly was incorporated in the coin-type battery case as shown in FIG. 1, and a solution of ethylene carbonate (EC) and dimethyl carbonate (DMC) in a volume ratio of 1:1 in which 1 M LiFSI was dissolved was injected as an electrolyte, and then sealed with a gasket to manufacture a coin-type secondary battery.

### Example 2

A coin-type secondary battery was manufactured in the same manner in Example 1, except that in Example 1, the conductive polymerlayer precursor solution prepared in Preparation Example 4 was coated (spray coated) onto the surface where the first case, the second case, the spring, and the spacer as a coin-type battery case could come into contact with the electrolyte solution.

### Example 3

A coin-type secondary battery was manufactured in the same manner in Example 1, except that in Example 1, the conductive epoxy layer precursor solution prepared in Preparation Example 5 was coated (spray coated) onto the surface where the first case, the second case, the spring, and the spacer as a coin-type could come into contact with the electrolyte solution.

### Example 4

A coin-type secondary battery was manufactured in the same manner in Example 1, except that in Example 1, the conductive carbon layer precursor solution prepared in Preparation Example 2 was coated (spray coated) onto the surface where the first case, the second case, the spring, and the spacer as a coin-type battery case could come into contact with the electrolyte solution.

### Example 5

A coin-type secondary battery was manufactured in the same manner in Example 1, except that in Example 1, the conductive carbon layer precursor solution prepared in Preparation Example 3 was coated (spray coated) onto the surface where the first case, the second case, the spring, and the spacer as a coin-type battery case could come into contact with the electrolyte solution.

### Comparative Example 1

A coin-type secondary battery was manufactured in the same manner in Example 1, except that in Example 1, any coating treatment was not performed onto the surface where the first case, the second case, the spring, and the spacer as a coin-type battery case could come into contact with the electrolyte solution.

### Experimental Example 1

The coin cell batteries manufactured in Examples 1 to 5 and Comparative Example 1 were charged and discharged 100 times under the following conditions, and then the 100-time discharge capacity retention relative to the one-time discharge capacity was calculated, and the results are shown in Table 1 below.

Charge: 0.3 C, CC/CV, 4.25V, 1/20 C cut-off

Discharge: 0.3 C, CC, 3.0V, cut-off

TABLE 1

| | 100-time capacity |
|---|---|
| | retention (%) |
| Example 1 | 99 |
| Example 2 | 96 |
| Example 3 | 99 |
| Example 4 | 95 |
| Example 5 | 97 |
| Comparative | 62 |
| Example1 | |

Referring to Table 1, it can be confirmed that when the conductive layer is formed according to the present disclosure, it exhibits excellent lifetime characteristics as compared with Comparative Example 1 that was failed to take any action.

### Experimental Example 2

The coin cell batteries manufactured in Examples 1 and 4 and 5 were rate-evaluated under the following conditions.

[1 to 3rd cycle charge/discharge conditions]

Charge: 0.1 C, CC/CV, 4.25V, 1/20 C cut-off

Discharge: 0.1 C, CC, 3.0V, cut-off

[4 to 6th cycle charge/discharge conditions]

Charge: 0.1 C, CC/CV, 4.25V, 1/20 C cut-off

Discharge: 2 C, CC, 3.0 V, cut-off

The capacity retention of the average discharge capacity value at 2 C obtained in the 4th to 6th cycle relative to the average discharge capacity value at 0.1 C obtained in the initial 3-time charge/discharge was calculated, and the results are shown in Table 2 below.

TABLE 2

| | 2C discharge |
|---|---|
| | capacity retention (%) |
| Example 1 | 89 |
| Example 4 | 60 |
| Example 5 | 75 |

Referring to Table 2, it can be confirmed that when the conductive carbon layer containing a conductive material other than graphene was coated according to Preparation Examples 2 and 3, metal corrosion can be prevented in Experimental Example 1 and thus lifetime characteristics are excellent, but compared with the case of using graphene, the conductivity is reduced by the coating and the rate characteristic is lowered, which is thus not preferable.

### Example 6

The conductive carbon layer precursor solution prepared in Preparation Example 1 was coated (spray coated) onto the housing part of the cylindrical battery case, the beading part and the upper end cap.

A positive electrode mixture having a composition of 95 wt. % of positive active material (LiNi_{0.6}Co_{0.2}Mn_{0.2}O₂), 2.5 wt. % of Super-P (conductive material), and 2.5 wt. % of PVDF (binder) was added to NMP (N-methyl-2-pyrrolidone) as a solvent to prepare a positive electrode slurry, and then the slurry was coated (100 μm) onto an aluminum current collector substrate to prepare a coin-type positive electrode.

A negative electrode mixture having a composition of 95 wt. % of artificial graphite, 2.5 wt. % of Super-P (conductive material), and 2.5 wt. % of PVDF (binder) was added to NMP (N-methyl-2-pyrrolidone) as a solvent to prepare a negative electrode slurry, and then the slurry was coated (100 μm) onto a copper current collector substrate to prepare a coin-type negative electrode.

A polyethylene-based separator was interposed between the prepared positive electrode and negative electrode to prepare an electrode assembly, and the electrode assembly was incorporated in the cylindrical battery case as shown in FIG. 1, and a solution of ethylene carbonate (EC) and dimethyl carbonate (DMC) in a volume ratio of 1:1 in which 1 M LiFSI was dissolved was injected as an electrolyte, and then sealed with a gasket to manufacture a cylindrical secondary battery.

### Example 7

A cylindrical secondary battery was manufactured in the same manner in Example 6, except that in Example 7, the conductive polymer layer precursor solution prepared in Preparation Example 4 was coated onto the housing part of the cylindrical battery case, the beading part and the upper end cap.

### Example 8

A cylindrical secondary battery was manufactured in the same manner in Example 6, except that in Example 8, the conductive epoxy layer precursor solution prepared in Preparation Example 5 was coated onto the housing part of the cylindrical battery case, the beading part and the upper end cap.

### Example 9

A cylindrical secondary battery was manufactured in the same manner in Example 6, except that in Example 9, the conductive carbon layer precursor solution prepared in Preparation Example 3 was coated onto the housing part of the cylindrical battery case, the beading part and the upper end cap.

### Comparative Example 2

A cylindrical secondary battery was manufactured in the same manner in Example 6, except that in Comparative Example 2, any coating treatment was not performed onto the housing part of the cylindrical battery case, the beading part and the upper end cap.

### Comparative Example 3

A cylindrical secondary battery was manufactured in the same manner in Example 6, except that in Comparative Example 2, Cr metal was electrolytically-plated and coated onto the housing part of the cylindrical battery case, the beading part and the upper end cap.

### Comparative Example 4

A cylindrical secondary battery was manufactured in the same manner in Example 6, except that in Comparative Example 4, the binder solution prepared in Preparation Example 6 was coated onto the housing part of the cylindrical battery case and the beading part. In the case of coating the upper end cap with a binder solution, it acts as a resistance of a large current, and thus the lifetime characteristics cannot be evaluated. Therefore, the binder coating was formed only on the housing part and the beading part.

### Experimental Example 3

The cylindrical secondary batteries manufactured in Examples 6 to 9 and Comparative Examples 2 to 4 were charged and discharged 50 times under the following conditions, and then the 50-time discharge capacity retention relative to the one-time discharge capacity was calculated, and the results are shown in Table 3 below.

Charge: 0.3 C, CC/CV, 4.25V, 1/20 C cut-off

Discharge: 0.3 C, CC, 3.0 V, cut-off

TABLE 3

| | 50-time capacity |
|---|---|
| | retention (%) |
| Example 6 | 99 |
| Example 7 | 96 |
| Example 8 | 99 |
| Example 9 | 97 |
| Comparative | 45 |
| Example 2 | |
| Comparative | 75 |
| Example 3 | |
| Comparative | 55 |
| Example 4 | |

Referring to Table 3, it can be confirmed that when the conductive layer is formed according to the present disclosure, it exhibits excellent lifetime characteristics as compared with Comparative Example 2 electrolytically coated with another metal and Comparative Example 3 in which a binder layer was formed,

### Experimental Example 4

The cylindrical secondary batteries manufactured in Examples 6 and 9 were rate-evaluated under the following conditions.

[1 to 3rd cycle charge/discharge conditions]

Charge: 0.1 C, CC/CV, 4.25V, 1/20 C cut-off

Discharge: 0.1 C, CC, 3.0V, cut-off

[4 to 6th cycle charge/discharge conditions]

Charge: 0.1 C, CC/CV, 4.25V, 1/20 C cut-off

Discharge: 2 C, CC, 3.0 V, cut-off

The capacity retention of the average discharge capacity value at 2 C obtained in the 4th to 6th cycle relative to the average discharge capacity value at 0.1 C obtained in the initial 3-time charge/discharge was calculated, and the results are shown in Table 4 below.

TABLE 4

| | 2C discharge |
|---|---|
| | capacity retention (%) |
| Example 6 | 89 |
| Example 9 | 80 |

Referring to Table 4, it can be confirmed that even if the same conductive carbon layer is formed, the use of graphene exhibits superior rate characteristics than when acetylene black is used.

Based on the above disclosure, it will be understood by those of ordinary skill in the art that various applications and modifications can be made within the scope and spirit of the present disclosure.

### INDUSTRIAL APPLICABILITY

As described above, since the secondary battery according to the present disclosure has a conductive layer formed on a part or the whole of the inner surface of the battery case capable of coming into contact with the electrolyte solution, and additionally on the outer surface of the components, and thus it is possible to wholly cover the part that can be corroded by the electrolyte solution without reducing the conductivity, and effectively prevent the corrosion.

1. A secondary battery, comprising:
a battery case made of metal;
an electrode assembly including a positive electrode, a separator, and a negative electrode, the electrode assembly being housed in the battery case together with an electrolyte solution; and
a conductive layer made of one selected from the group consisting of: a conductive carbon layer, a conductive polymer layer, or a conductive epoxy layer, the conductive layer coating a part of or an entirety of an inner surface of the battery case, the conductive layer coming into contact with the electrolyte solution.

2. The secondary battery according to claim 1, wherein:
the electrode assembly is a coin-type electrode assembly,
the battery case comprises a first case housing the electrode assembly; and a second case covering the upper end part of the first case,
the conductive layer coats a portion of the inner surface where the first case and the second case come into contact with the electrolyte solution, and
the conductive carbon layer comprises graphene.

3. The secondary battery according to claim 2, wherein:
the secondary battery further comprises a spring and a spacer that fill an inner space of the battery case excluding the electrode assembly, the spring and the spacer are made of metal,
the conductive layer coats a portion of the inner surface where the spring and the spacer come into contact with the electrolyte solution, and
the conductive carbon layer comprises graphene.

4. The secondary battery according to claim 2, further comprising a gasket sealing the first case and the second case to one another.

5. The secondary battery according to claim 1, wherein:
the secondary battery is a cylindrical secondary battery,
the electrode assembly is a jelly-roll type or stack/folding type electrode assembly,
the battery case comprises a cylindrical can that includes a housing part in which the electrode assembly and the electrolyte solution are housed together and a beading part located at an upper part of the housing part; and a cap assembly that is mounted on an open upper end part of the cylindrical can and comprises an upper end cap having a protrusion-type electrode terminal, and
the conductive layer coats a bottom surface of the cylindrical can and a part of or an entirety of an inner surface of the cap assembly facing an inner surface of the cylindrical can.

6. The secondary battery according to claim 5, wherein:
a gasket is mounted on an upper part of the beading part of the cylindrical can,
the cap assembly has a safety device for current interruption (PTC device) and a safety vent for internal pressure drop stacked under the upper end cap, and a current interruption device (CID) located at a lower end of the safety vent,
the electrode assembly comprises a positive electrode tab and a negative electrode tab that extend out from the electrode assembly, wherein the positive electrode tab is connected to the cap assembly, and the negative electrode tab is connected to a bottom surface of the cylindrical can spaced apart from the housing part of the cylindrical can, and
the conductive layer coats at least one member selected from the group consisting of: the top cap, the bottom surface of the cylindrical can, the safety device for current interruption, the safety vent, the current interruption device, the positive electrode tab, or the negative electrode tab.

7. The secondary battery according to claim 1, wherein:
the secondary battery is a prismatic secondary battery,
the electrode assembly is a jelly-roll type or stack/folding type electrode assembly,
the battery case comprises a rectangular can body that open at an upper end thereof and that houses the electrode assembly and the electrolyte solution together; and a top cap including cap terminals that are coupled and sealed to the upper end of the can body and are connected to the electrode terminals of the electrode assembly, and
the conductive layer coats a surface of the cap terminals of the top cap facing toward an inner surface of the rectangular can body.

8. The secondary battery according to claim 7, wherein:
the electrode assembly comprises a positive electrode tab and a negative electrode tab extending from the electrode assembly, the positive tab and the negative tab are respectively connected to corresponding ones of the cap terminals, and
the conductive layer coats an inside surface of the rectangular can body, and at least one member selected from the group consisting of the positive electrode tab or the negative electrode tab.

9. The secondary battery according to claim 5, wherein the metal of the battery case is any one selected from the group consisting of: aluminum, nickel, stainless steel (SUS), copper, iron, bronze, or brass.

10. The secondary battery according to claim 5, further comprising a hollow center pin inserted into a center of the electrode assembly.

11. The secondary battery according to claim 1, wherein: the conductive layer has a thickness of 0.01 μm to 100 μm.

12. The secondary battery according to claim 5, wherein the conductive carbon layer comprises graphene and a binder polymer.

13. The secondary battery according to claim 5, wherein the conductive polymer layer comprises at least one conductive polymer selected from the group consisting of: poly(3,4-ethylenedioxythiophene)/poly(4-styrene sulfonate (PEDOT/PSS), polyaniline (PANI), polypyrrole (PPy), polythiophene (PT), polyacetylene (PA), or poly para-phenylene vinylene (PPV).

14. The secondary battery according to claim 5, wherein: the conductive epoxy resin layer comprises at least one conductive filler selected from the group consisting of: gold, platinum, silver, copper, or nickel metal powder, carbon or carbon fiber, graphite, composite powder, or an epoxy polymer.
